(19) United States
(12) Patent Application Publication
(10) Pub. No.: US 2023/0214691 A1
(43) Pub. Date: Jul. 6, 2023

(54) Fatigue Crack Growth Prediction

(71) Applicant: General Electric Company, Schenectady, NY (US)

(72) Inventors: Siyu Wu, San Ramon, CA (US); Alireza Dibazar, San Ramon, CA (US); Craig Wesley Stevens, Revere, MA (US); Lauren Ashley Vahldick, Boston, MA (US); Timothy Ryan Greene, San Mateo, CA (US); Louis Christopher Nucci, Byfield, MA (US)

(21) Appl. No.: 18/182,660

(22) Filed: Mar. 13, 2023

Related U.S. Application Data
(62) Division of application No. 15/910,412, filed on Mar. 2, 2018.
(60) Provisional application No. 62/576,234, filed on Oct. 24, 2017.
(60) Provisional application No. 62/470,539, filed on Mar. 13, 2017.

(51) Int. Cl. G06N 5/04; G06N 20/00; G06F 30/17; G06F 30/20; G06N 20/20; G06N 5/01; G06N 7/01

(52) U.S. Cl. CPC G06N 5/04; G06N 20/00; G06F 30/17; G06F 30/20; G06N 20/20; G06N 5/01; G06N 7/01; G06F 30/15

(57) ABSTRACT

Systems and methods for predicting fatigue crack growth are provided. In one example embodiment, a method can include obtaining historical operational data associated with one or more rotatable structures of one or more machines, obtaining data indicative of fatigue crack size for the one or more rotatable structures, and constructing a machine-learned model correlating fatigue crack growth with operational data using a machine learning technique.

### PRIORITY CLAIM

The present application claims priority to, and is a divisional application of, U.S. patent application Ser. No. 15/910,412 filed on Mar. 2, 2018, which claims the benefit of priority of: U.S. Provisional Patent Application No. 62/576,234, entitled “FATIGUE CRACK GROWTH PREDICTION,” filed Oct. 24, 2017; and U.S. Provisional Patent Application No. 62/470,539 entitled “FATIGUE CRACK GROWTH PREDICTION,” filed Mar. 13, 2017. All of these applications are incorporated herein by reference for all purposes.

### FIELD

The present subject matter relates generally to digital systems for predicting fatigue crack growth in machinery including rotatable structures, such as rotors for gas turbine engines.

### BACKGROUND

Material fatigue is a common phenomenon where structures fail when subjected to a cyclic load. If the loads exceed a certain threshold, microscopic cracks begin to form at spots where stress concentrate. Eventually, a crack will propagate to a critical size, and the structure will fracture. As a result, accurate tracking of crack growth can be important for ensuring availability, reliability, and safety of operation across various industrial domains, including aviation.

Fatigue crack growth can be influenced by a large variety of factors, such as temperature, load, surface condition, size, metallurgical microstructure, presence of oxidizing or inert chemicals, residual stresses, corrosion, fretting, etc. In addition, crack growth can be a highly nonlinear process with distinct stages of progression. Given these challenges, most existing methods that determine fatigue crack growth adopt a physics-based approach, such as linear elastic fracture mechanics (LEFM) which is computationally intensive and may not be ideal for near real-time or real-time application.

### BRIEF DESCRIPTION

Aspects and advantages of embodiments of the present disclosure will be set forth in part in the following description, or may be learned from the description, or may be learned through practice of the embodiments.

One example aspect of the present disclosure is directed to a computing system, comprising one or more processors, and one or more memory devices. The one or more memory devices store computer-readable instructions that when executed by the one or more processors cause the one or more processors to perform operations for constructing a machine-learned model correlating fatigue crack growth with operational data. The operations comprise obtaining historical operational data associated with one or more rotatable structures of one or more machines, obtaining data indicative of fatigue crack size for the one or more rotatable structures, and constructing a machine-learned model correlating fatigue crack growth with operational data using a machine learning technique.

Another example aspect of the present disclosure is directed to a computer-implemented method for predicting fatigue crack growth. The method includes obtaining, by one or more processors, operational data associated with one or more rotatable components of a machine. The method includes accessing, by the one or more processors, a non-physics based model correlating operational data with fatigue crack growth. The non-physics based model is constructed using a machine learning technique based on historical operational data. The method includes determining, by the one or more processors, fatigue crack growth associated with the one or more rotatable components based at least in part on the model and the operational data.

Another example aspect of the present disclosure is directed to a tangible, non-transitory computer-readable medium storing computer-readable instructions that when executed by one or more processors cause the one or more processors to perform operations. The operations include obtaining historical operational data associated with one or more rotatable structures of each of a plurality of machines, obtaining data indicative of fatigue crack size for the one or more rotatable structures of each of the plurality of machines, and constructing a machine-learned model correlating fatigue crack growth with operational data using a machine learning technique.

Variations and modifications can be made to these example embodiments of the present disclosure. These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a flow diagram of an example method according to example embodiments of the present disclosure;

FIG. 2 depicts a flow diagram of an example method according to example embodiments of the present disclosure;

FIG. 3 depicts fatigue crack growth divided into four different growth regions according to example embodiments of the present disclosure;

FIG. 4 depicts a graphical representation of example operation cycles that can be used as a feature input to a model according to example embodiments of the present disclosure;

FIG. 5 depicts a flow diagram of an example method according to example embodiments of the present disclosure; and

FIG. 6 depicts an example computing system according to example embodiments of the present disclosure.

### DETAILED DESCRIPTION

Reference now will be made in detail to embodiments of the disclosure, one or more examples of which are illustrated in the drawings. Each example is provided by way of explanation of the disclosed technology, not limitation of the disclosed technology. In fact, it will be apparent to those skilled in the art that various modifications and variations can be made in the present disclosure without departing from the scope or spirit of the claims. For instance, features illustrated or described as part of one embodiment can be used with another embodiment to yield a still further embodiment. Thus, it is intended that the present disclosure covers such modifications and variations as come within the scope of the appended claims and their equivalents.

As used in the specification and the appended claims, the singular forms “a,” “an,” and “the” include plural referents unless the context clearly dictates otherwise. The use of the term “about” in conjunction with a numerical value refers to within 25% of the stated amount.

Example aspects of the present disclosure are directed to systems and methods for fatigue crack growth prediction. Aspects of the present disclosure may be discussed with reference to fatigue crack growth in a rotor shaft of a gas turbine engine used for aviation (e.g., to provide propulsion for an aircraft). However, those of ordinary skill in the art, using the disclosures provided herein, will understand that aspects of the present disclosure can be used to predict fatigue crack grown for any type of rotatable structure in a variety of applications, such as wind turbines, jet engines, turboprop engines, aeroderivative gas turbines, amateur gas turbines, auxiliary power units, gas turbines for power generation, turboshaft engines, radial gas turbines, scale jet engines, microturbines, internal combustion engines, electric engines, drills and other tools/equipment, transmissions, or other applications.

According to example embodiments, data recorded by one or more monitoring systems configured to monitor parameters of a machine including one or more rotatable components during operation are provided. For example, the parameters of a gas turbine engine of an aerial vehicle during flight (“e.g., flight data”), the parameters of a turbine machine during steam, water, or wind power generation (“e.g., power data”), or the parameters of an internal combustion engine or transmission during driving (“e.g., drive data”) can be collected. The operational data can include parameters such as core speed, temperature, torque, acceleration, etc. associated with a gas turbine engine or other machine. In one example, operational data is flight data comprising high-frequency sensory data collected by an on-board flight recorder. Power data and drive data can also be collected by on-board operation recorders. Machine learning techniques can be used to construct one or more models mapping the operational data to fatigue crack growth. The one or more models can each be non-physics based models. By way of example, the model(s) can be used to predict, cycle by cycle, crack growth for individual rotors of gas turbine engines based on actual usage. Similarly, the model(s) can be used to predict, cycle by cycle, crack growth for individual gears in a transmission, individual shafts or rotors in a turbine, engine or transmission, etc. It will be appreciated that models can be generated using any operational data associated with the rotatable components of a machine.

Example aspects of the present disclosure can provide a number of technical effects and benefits. For instance, use of machine learning techniques to construct model(s) mapping operational data to fatigue crack growth can bypass complex calculations used in physics-based model computations, such as calculating stress intensity factor and other complex LEFM parameters. The can allow for processing and storage resources to be used for other functions. Moreover, the model constructed according to example aspects of the present disclosure can be an analytical model that can allow for almost instantaneous prediction of fatigue crack growth based on actual usage. The analytical model can provide accurate near real-time or real-time fatigue crack prediction. Benefits of predicting fatigue crack growth using a model constructed according to example embodiments of the present disclosure can include: (1) setting safe and appropriate interfaces for component removal and repair; (2) prolonging the functioning time of assets; and (3) optimizing asset operation and its correlation to field issues.

Example aspects of the present disclosure can provide an improvement in computing technology. For instance, the use of machine learning instead of physics based computations can provide for the development of models that are easier to evaluate relative to physics-based models for the prediction of fatigue crack growth. This can save processing and storage resources of a computing system. The model(s) can also provide for the faster processing and prediction of fatigue crack growth.

In example embodiments, maintenance operations such as component inspection, repair, and/or replacement can be selected using the model. For example, the system may receive operational data for a component or a machine associated with a component. The system can determine predicted crack growth based using the data and the model. The system can then schedule and/or perform maintenance operations based on the predicted crack growth. In some examples, the system can generate automated maintenance messages associated with components based on indications of predicted fatigue crack growth. Such techniques can optimize component life while minimizing downtime associated with maintenance operations. For example, unnecessary or premature maintenance operations can be avoided by predicting when a crack will reach a size that merits maintenance operation.

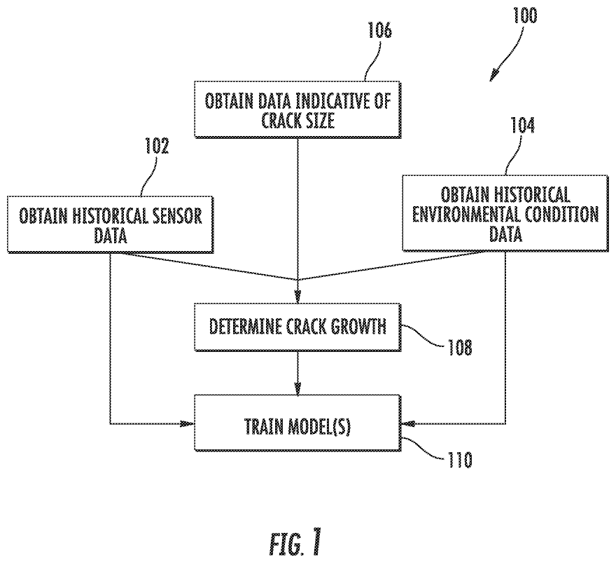

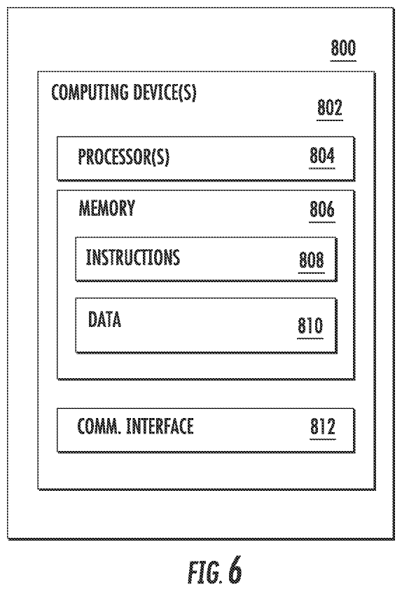

FIG. 1 depicts a flow diagram of an example method (100) for constructing a fatigue crack growth prediction model according to example embodiments of the present disclosure. The method can be implemented by any suitable computing system, such as the computing system depicted in FIG. 6. In addition, although FIG. 1 depicts steps performed in a particular order for purposes of illustration and discussion. Those of ordinary skill in the art, using the disclosures provided herein, will understand that various steps of any of the methods or processes disclosed herein can be adapted, expanded, performed simultaneously, omitted, and/or rearranged without deviating from the scope of the present disclosure.

In example embodiments, method 100 may be performed by one or more first computing devices such as one or more first processors. The one or more first processors may monitor operation of a first plurality of machines using a first plurality of sensors. For example, one or more processors associated with a health and usage monitoring system (HUMS) may collect data from a plurality of sensors for a plurality of aerial vehicles in a fleet of aircraft.

At (102), the method includes obtaining historical sensor data for parameters that can affect fatigue crack growth. The historical sensor data can be operational data such as flight data, power data, or drive data and can include parameters related to operations of rotatable components such as rotors, shafts, gears, etc. In some embodiments, the sensor data can be data collected by a health and usage monitoring system (HUMS), that can include a comprehensive and continuous recording of parameters associated with actual component operation such as actual rotor operation. The parameters can include, for instance, core speed, temperature, torque, acceleration, etc. The historical sensor data can be historical operational data associated with one or more rotatable structures of one or more machines, such as a first aerial vehicle or a first set of aerial vehicles. In some examples, (102) may comprise monitoring operation of a first plurality of machines using a first plurality of sensors to determine the historical operational data. In example embodiments, (102) may include using full flight data, such as operational data including engine parameters, environmental parameters, and other vehicle parameters.

At (104), the method can include obtaining historical environmental condition data. The historical environmental condition data can include data associated with the environment in which the machine operates. For example, historical environmental condition data for a gas turbine engine may include ambient temperature, operating conditions, and other data associated with the operating environment of the gas turbine engine.

At (106), the method can include obtaining data indicative of actual fatigue crack size. This can be used to determine ground truth for training the model. The data indicative of actual fatigue crack size can be obtained in a variety of manners. For instance, the data can be obtained through direct measurement. The data can be obtained through LEFM. The data can obtained through other physics-based approaches with or without the use of operational data.

At (108), data indicative of fatigue crack growth can be determined based on the data indicative of crack size. The sensor data and/or the environmental data can be considered in some embodiments in determining fatigue crack growth. The data indicative of fatigue can be used as a dependent variable in training a model such as a machine-learned model or other non-physics based model. The data indicative of fatigue crack growth can be, for instance, indicative of fatigue crack growth rate or absolute crack growth.

At (110), machine learning techniques can be used to train the model based on the data indicative of fatigue crack growth and the flight data. Environment data can be considered in some embodiments in training the model. Any suitable type of model can be constructed according to example embodiments of the present disclosure. For instance, a random forest model (“RF model”) and/or a neural network model (“NN model”) can be constructed. In some embodiments, non-linear regression with or without regularization can be used. In some embodiments, one or more of gradient boost machine, artificial neural network, self-organizing maps, and/or deep learning can be used.

In some embodiments, two types of RF models can be constructed. For instance, an RF classification model can be constructed to identify crack growth regions. In addition, an RF regression model of fatigue crack growth rate within each crack growth region can be constructed.

For RF models, data indicative of fatigue crack growth rate can be used as the dependent variable for the model. Crack size can be defined as crack length along a given dimension or area of the crack. For modeling crack area, logarithmic transformation of crack growth rate can be used before training the model. For modeling crack length, logarithmic transformation of crack growth rate may not be required before training the model.

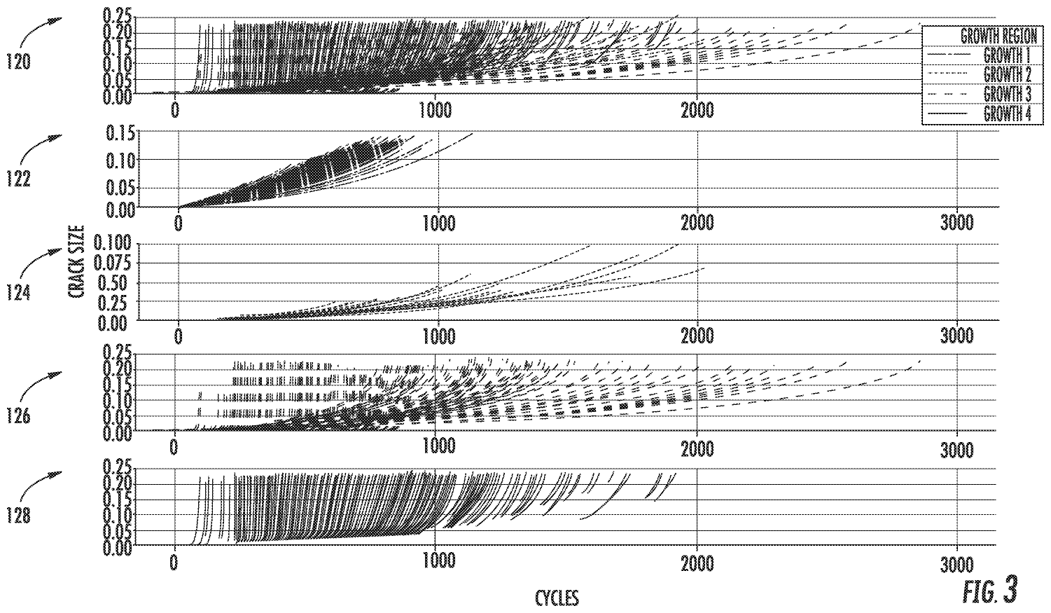

For the RF classification model, the total number of regions can vary depending on the observed patterns from training data. FIG. 3 shows one example when crack growth is divided into four different growth regions. For the RF classification model, training data of imbalanced classes, not balanced classes, may be intentionally used to combat the error propagation for conducting the n-step ahead prediction using the RF models. By way of example, some classes may have more data points, such as classes without slow crack growth as compared to classes with faster crack growth. Models may tend to bias toward classes including more data points. Typically, the use of balanced classes may be forced by selecting equal numbers of samples from each class. Such a balanced approach may not be ideal for modeling crack growth, however. Accordingly, for a classification model in example embodiments, training data of imbalanced classes may be used. Because of differences in fatigue crack growth rate, the system may select randomly or using predetermined rules. For the RF classification model, current crack size may, or may not be used as a predictor. For the RF regression model, a conservative adjustment mechanism, i.e., multiply the predicted crack growth by a less than 100% coefficient, may, or may not use when implementing the models for n-step ahead prediction.

In some embodiments, an NN classification model can be constructed. The current crack size may or may not be used as a predictor. A starting point of training data may or may not be implemented.

For an NN model, crack growth rate, absolute crack growth, and/or crack size can be the dependent variable for the model. For modeling both crack area and length, logarithmic transformation of the dependent variable may or may not be performed.

In some embodiments, crack growth rate can be defined as follows:

$$crack growth rate ( k ) = \frac{cracksize ( k + 1 ) - c r a c k s i z e ( k )}{c r a c k s i z e ( k )}$$

Defining crack growth rate as a percentage increase as set forth above can provide more meaningful output for the model.

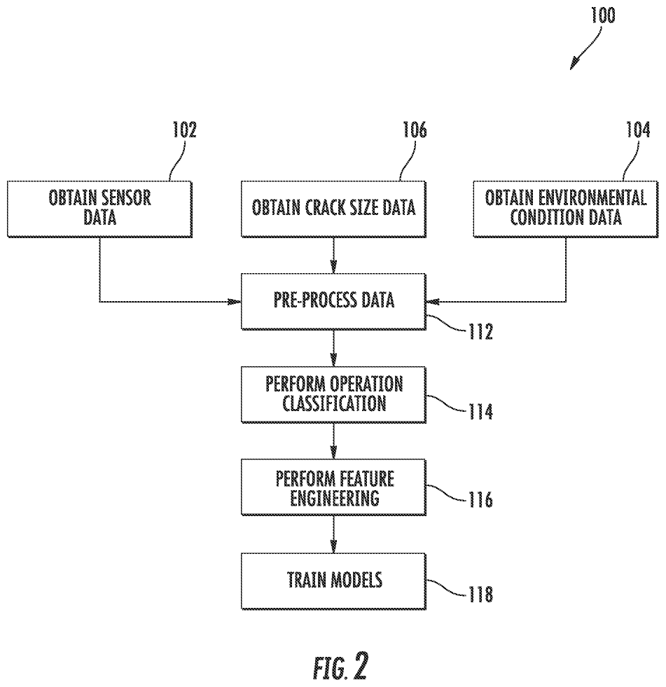

FIG. 2 depicts a flow diagram of an example method 101 for training a model using machine learning according to example embodiments of the present disclosure. The model can be a machine-learned model. As discussed above, the model can be trained by obtaining operational data (102), obtaining data indicative of fatigue crack size (106), and/or by obtaining environmental condition data (104).

At (112), the method can include pre-processing the data. For instance, the raw operational data such as flight data can be processed to identify quality issues caused by malfunctioning sensors, incomplete or duplicate data ingestion, incorrect data type conversion through transfer or storage, etc.

At (114), the method can include performing operation classification. For instance, operations can be classified based on the pre-processed operational data. Operations that are suitable for machine learning model development can be identified.

In some embodiments, operations can be classified based on a growth region associated with fatigue crack growth. With reference to FIG. 3, for example, fatigue crack growth may be viewed as having four distinct regions of growth. The regions include multiple different stages of crack formation and growth, beginning with crack initiation to the crack reaching a critical size (e.g., that may result in failure of the component). For instance, FIG. 3 depicts a first graph 120 illustrating an overlay of lines representing crack growth in each different crack growth region. FIG. 3 depicts a second graph 122 illustrating the crack growth in a first crack growth stage where the crack growth is somewhat linear relative to the number of cycles. FIG. 3 depicts a third graph 124 illustrating the crack growth in a second crack growth stage where the crack growth has a very small increase by cycle, followed by a larger and increasing rate of crack growth. FIG. 3 depicts a fourth graph 126 illustrating the crack growth in a third crack growth stage where the crack growth proceeds somewhat linearly, followed by a rapid increase in the crack growth rate. FIG. 3 depicts a fifth graph 128 illustrating the crack growth in a fourth crack growth stage where there is little crack growth, followed by a rapid increase in the crack growth rate.

At (114), an operation can be classified according to a corresponding crack growth region or stage. In some examples, a model may be created for each different fatigue crack growth region. Accordingly, operations can be divided into different regions and the operation data used for training the model for the corresponding region. The use of four crack growth regions and a corresponding number of models to model crack growth is provided by way of example only. Any number of regions and models may be used.

At (116), the method can include feature engineering to determine appropriate features based on the operational data for training the model(s). Example features are discussed in detail below.

In some embodiments, dwell time features are determined. Dwell time features can include a duration of a flight, power generation process, drive, or any other movement event while selected engine parameters remain within certain ranges specified by upper and lower bounds. For an engine for example, selected engine parameters can include, for instance, temperature at various locations, core engine speed, acceleration, etc. Upper and lower bounds can be determined for individual engines separately or various engines collectively. Similar parameters and bounds may be used for other machines such as transmissions, tools, etc.

In some embodiments, time-at-value features and time-above-value features are determined. For instance, time-at-value features and time-above-value features can include the duration of flight while selected engine parameters remain at or above selected lower bounds. Selected operational parameters can include temperature at various locations, core engine speed, torque, acceleration, etc. Lower bounds can be extracted from individual machines separately or various machines collectively.

In some embodiments, rolling window features can be determined. Rolling window features can include, for instance, statistical aggregated values, or their combinations, of selected machine parameters during a rolling window of selected lengths. Statistical aggregation functions can include mean, median, maximum, minimum, standard deviation, interquartile range, sum, product, counts of pre-selected values, cumulative values of all forgoing functions, logarithmic transformation of all forgoing functions, etc. Combinations can include product, division, subtraction, sum, exponential power of another feature, etc. For certain features that are combined, non-uniform rolling window lengths may or may not be used. Selected engine or other machine parameters include but are not limited to temperature at various location and core engine speed, torque, acceleration, etc. Depending on the sampling interval, rolling window lengths vary from 1 sampling interval to maximum length among known flights or other operations.

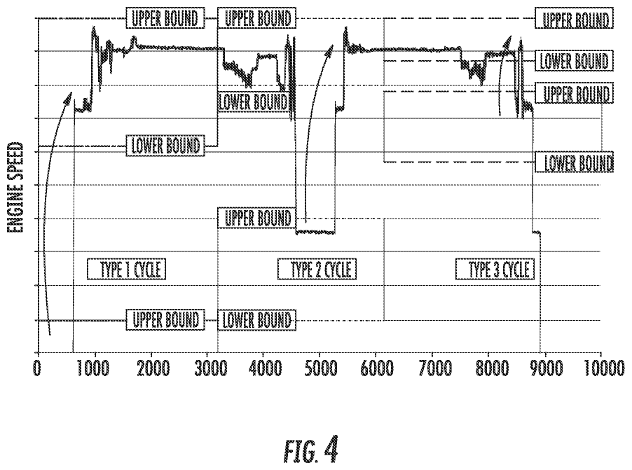

In some embodiments, counts of known operation cycles related to fatigue can be determined. Certain operation cycles as shown in FIG. 4, defined as a complete cycle moving from one engine speed band (dictated by an upper and a lower threshold) to another speed band, and then return to the original engine speed band, are known factors that impact crack growth. Counts of such operation cycles can be used as input features. Similar speed bands may be used for transmission and other machines having rotatable structures.

In some embodiments, cumulative features across different flights executed by the same engine are determined. All features above can be extracted from individual flights. However, one particular engine may execute thousands of flights in its life span. The cumulative effect of all above features across different missions can therefore also be used as input features. Similarly cumulative features across different drives, power generation processes, or other operational windows of a machine can be determined.

In some embodiments, feature optimization can be performed. Processing the historical operational data can include determining one or more input features for training the machine-learned model or other non-physics based model using a machine learning technique. Feature groups can be identified based on similarity. During the model training, important features can be identified based on the particular machine (e.g., engine, transmission, tool, etc.) location/part where crack grows. These important features are then used as the optimized features for machine learning models. Important features may also be identified based on individual machines.

At (118), the method can include training, tuning, and cross-validating the one or more models. In some embodiments, the one or more models can map the input features to crack growth rate or other dependent variable for each cycle.

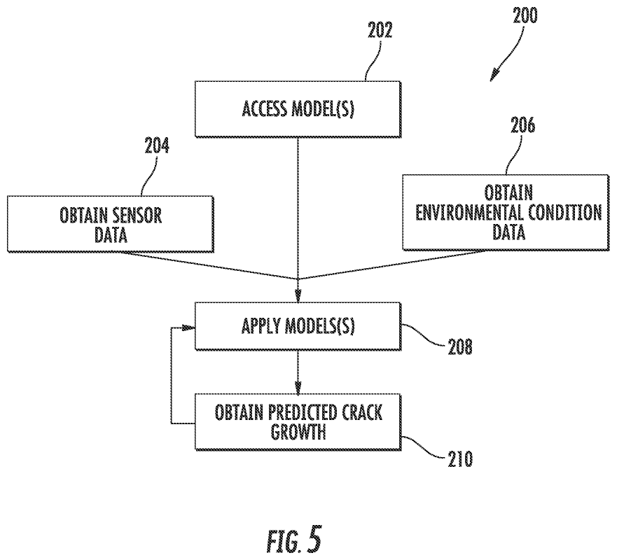

FIG. 5 depicts a flow diagram of an example method (200) of using a model constructed according to example aspects of the present disclosure to predict fatigue crack growth based on flight or other operational data in real-time or near-real time. In example embodiments, the model can be a machine-learned model. The method (200) can be implemented by any suitable computing system, such as the computing system depicted in FIG. 6. In addition, although FIG. 1 depicts steps performed in a particular order for purposes of illustration and discussion. Those of ordinary skill in the art, using the disclosures provided herein, will understand that various steps of any of the methods or processes disclosed herein can be adapted, expanded, performed simultaneously, omitted, and/or rearranged without deviating from the scope of the present disclosure.

In example embodiments, method 200 may be performed by one or more second computing devices such as one or more second processors, while method 100 is performed by one or more first processors. The one or more second processors may be configured to predict crack growth for a second plurality of machines using a previously trained model. For example, the one or more second processors may provide operational data for a second plurality of aerial vehicles to the machine-learned model and receive as output an indication of predicted fatigue crack growth associated with rotatable components of the second plurality of aerial vehicles.

At (202), the method can include accessing the model. The model can be previously trained using machine learning techniques as discussed above. The model can correlate operational data with fatigue crack growth. The method can include obtaining sensor data (e.g., flight data) (204) and/or environmental condition data (206). In some examples, (204) may include monitoring operation of a second plurality of machines using a second plurality of sensors to determine operational data associated with the second plurality of machines. Based on the data, the model can be applied (208) to obtain predicted crack growth (210). The predicted crack growth (210) can be fed back to the model to for use in prediction of crack growth in the next cycle.

According to example embodiments of the disclosed technology, a machine-learned model is trained using historical operational data associated with one or more rotatable structures of at least a first machine. In some implementations, the system can input operational data associated with one or more additional machines to the model. For example, the model may be constructed to include one or more inputs configured to receive additional operational data associated with machines having additional rotatable structures. The model may include one or more outputs configured to provide an indication of predicted fatigue crack growth associated with the rotatable structures of the additional machines. The system can generate, as one or more outputs of the machine-learned model, indications of predicted fatigue crack growth associated with rotatable structures of the additional machines.

According to some aspects of the disclosed technology, the system can generate automated maintenance messages associated with machines or rotatable structures of machines based on indications of predicted fatigue crack growth. One or more maintenance operations can be performed in response to the automated maintenance messages. For example, a part may be replaced or inspected automatically in response to an automated maintenance message.

FIG. 6 depicts a block diagram of an example computing system that can be used to implement the systems and methods according to example embodiments of the present disclosure. As shown, the system can include one or more computing device(s) 802. The one or more computing device(s) 802 can include one or more processor(s) 804 and one or more memory device(s) 806. The one or more processor(s) 804 can include any suitable processing device, such as a microprocessor, microcontroller, integrated circuit, logic device, or other suitable processing device. The one or more memory device(s) 806 can include one or more computer-readable media, including, but not limited to, non-transitory computer-readable media, RAM, ROM, hard drives, flash drives, or other memory devices.

The one or more memory device(s) 806 can store information accessible by the one or more processor(s) 804, including computer-readable instructions 808 that can be executed by the one or more processor(s) 804. The instructions 808 can be any set of instructions that when executed by the one or more processor(s) 804, cause the one or more processor(s) 804 to perform operations. The instructions 808 can be software written in any suitable programming language or can be implemented in hardware. In some embodiments, the instructions 806 can be executed by the one or more processor(s) 804 to cause the one or more processor(s) 804 to perform operations. The memory device(s) 806 can further store data 810 that can be accessed by the processors 804. For example, the data 810 can include operational data (e.g., flight data), crack growth data, environmental condition data associated with a model, etc.

The one or more computing device(s) 802 can also include a communication interface 812 used to communicate, for example, with the other components of the system and/or other computing devices. The communication interface 812 can include any suitable components for interfacing with one or more network(s), including for example, transmitters, receivers, ports, controllers, antennas, or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and can include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A computing system, comprising:
one or more processors; and
one or more memory devices, the one or more memory devices storing computer-readable instructions that when executed by the one or more processors cause the one or more processors to perform operations for constructing a machine learning model correlating fatigue crack growth with operational data, the operations comprising:
obtaining data indicative of fatigue crack size a rotatable structure;
predicting fatigue crack growth for the rotatable structure using a machine learning model, wherein the machine learning model is constructed by:
obtaining historical data indicative of fatigue crack size for a plurality of rotatable structures;
classifying the historical data based on at least two regions of fatigue crack size;
training the machine learning model to predict fatigue crack growth based on the historical data and the classifications of the historical data based on the at least two regions of fatigue crack size.

2. The computing system of claim 1, wherein each of the at least two regions is defined by a range of crack sizes.

3. The computing system of claim 1, wherein a machine learning model is determined for each of the at least two regions of fatigue crack size.

4. The computing system of claim 1, wherein the at least two regions of fatigue crack size are determined according to different patterns of crack growth in the at least two regions.

5. The computing system of claim 1, wherein the historical data is further classified based on a dwell time and the machine learning model is trained to predict fatigue crack growth based on the dwell time.

6. The computing system of claim 5, wherein the dwell time includes duration of a movement event while at least one engine parameter remains within a range specified by an upper bound and a lower bound.

7. The computing system of claim 6, wherein a movement event includes a flight, a power generation process, or a drive.

8. The computing system of claim 6, wherein the at least one engine parameter includes at least one of temperature, core engine speed, or acceleration.

9. The computing system of claim 6, wherein the historical data is classified as one of at least two types of cycles based on the dwell time in a first engine speed band, with a first upper bound and a first lower bound, and the dwell time in a second engine speed band, with a second upper bound and a second lower bound.

10. The computing system of claim 9, wherein each of the at least two types of cycles includes moving from one engine speed band to another engine speed band and returning to the one engine speed band.

11. The computing system of claim 9, wherein the at least two types of cycles are defined by different engine speed bands.

12. The computing system of claim 1, wherein the historical data is further classified based on at least one time-above-value feature and the machine learning model is trained to predict fatigue crack growth based on the time-above-value feature.

13. The computing system of claim 1, wherein the historical data is further classified based on at least one rolling window feature and the machine learning model is trained to predict fatigue crack growth based on the at least rolling window feature.

14. The computing system of claim 13, wherein the at least one rolling window feature includes statistical aggregated values of at least one parameter.

15. The computing system of claim 14, wherein the statistical aggregated values include at least one of mean, median, maximum, minimum, standard deviation, interquartile range, sum, product, count, cumulative values, logarithmic transformation.

16. A method of constructing a machine learning model, the method comprising:
obtaining historical data indicative of fatigue crack size for a plurality of rotatable structures;
classifying the historical data based on at least two regions of fatigue crack size; and
training the machine learning model to predict fatigue crack growth based on the historical data and the classifications of the historical data based on the at least two regions of fatigue crack size.

17. The method of claim 16, wherein the at least two regions of fatigue crack size are determined according to different patterns of crack growth in the at least two regions.

18. The method of claim 16, which further includes classifying the historical data based on dwell time, and which further includes training the machine learning model to predict fatigue crack growth based on the dwell time.

19. The method of claim 16, which further includes classifying the historical data based on at least one rolling window feature, and which further includes training the machine learning model to predict fatigue crack growth based on the rolling window feature.

20. The method of claim 19, wherein the rolling window feature includes statistical aggregated values of at least one parameter, and wherein the statistical aggregated values include at least one of mean, median, maximum, minimum, standard deviation, interquartile range, sum, product, count, cumulative values, logarithmic transformation.
